(19) United States
(12) Patent Application Publication
(10) Pub. No.: US 2007/0133936 A1
(43) Pub. Date: Jun. 14, 2007

(54) Optical element and optical-loss measurement apparatus

(75) Inventors: Keisuke Sato, Kawasaki (JP); Masao Kondo, Kawasaki (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: FUJITSU LIMITED, Kawasaki (JP)

(21) Appl. No.: 11/387,688

(22) Filed: Mar. 24, 2006

(30) Foreign Application Priority Data
Dec. 12, 2005 (JP) 2005-358049

(51) Int. Cl. G02B 6/00; G02B 6/34; G02B 6/10

(52) U.S. Cl. 385/142; 385/141; 385/144; 385/129; 385/130; 385/131; 385/31; 385/36

(57) ABSTRACT

An optical deflection element is composed of a substrate 1 and an optical waveguide 2 formed on the substrate 1 and made of an electrooptic material. The optical waveguide 2 is composed of a lower clad layer 3, an upper clad layer 5, and a core layer 4, in which an optical path is formed, held between the lower clad layer 3 and an upper clad layer 5. The lower and upper clad layers 3, 5 are formed using a conductive oxide as a material, also serving as lower and upper electrodes to apply voltage to the core layer 4.

### CROSS-REFERENCE TO RELATED APPLICATIONS

This application is based upon and claims the benefit of priority from the prior Japanese Patent Application No. 2005-358049, filed on Dec. 12, 2005, the entire contents of which are incorporated herein by reference.

### BACKGROUND OF THE INVENTION

1. Field of the Invention

The present invention relates to an optical element used in technical fields such as optical communications and optical signal processing, and to an optical-loss measurement apparatus measuring optical loss of an optical waveguide being a component of the optical element.

2. Description of the Related Art

In recent years, transmission bands for optical communications show a continuous increase and become to have higher speed and larger capacity along with advance in a wavelength multiplexing technology. Elements that control lights of a light modulation, an optical switch and the like are actively developed. As a material producing these optical control elements, oxide dielectric has a great potential in view of its wider characteristics. The optical control is performed using oxide dielectric, and by applying voltage thereto. Therefore, the oxide dielectric requires electrodes at its upper side and lower side. However, when these electrodes are produced, the electrodes absorb the light, leading to optical loss.

Hence, in order to prevent light leakage to the electrodes, there is adopted a method that blocks the light in a core layer, in which an optical waveguide is provided with the core layer and a clad layer which are produced using oxide dielectrics having different refractive indexes as materials. For instance, in Japanese Patent Application Laid-Open No. 2004-37704 (Patent document 1), there is disclosed an optical waveguide element composed of a lower clad layer, a core layer, an upper clad layer and an upper electrode that are formed on a substrate, where a conductive substrate also serving as a lower electrode is adopted as a substrate, and in this case, a conductive substrate made of Nb—SrTiO₃ (STO) monocrystal is adopted.

According to the structure of Patent document 1, the substrate serving also as the lower electrode can facilitate downsizing and simplification of the structure. However, the optical waveguide has the same thickness as of the conventional structure, requiring relatively high voltage application thereto in order to apply enough voltage to the core layer of the optical waveguide. Here, there is a problem that the optical element consumes large voltage. Further, there is another problem that Nb—STO monocrystal tends to absorb a light of a desired wavelength, therefore when the monocrystal is used for the substrate, the optical loss amount of the optical waveguide is large.

### SUMMARY OF THE INVENTION

The present invention has been made in view of the above-described problems, and an object thereof is to provide a highly-reliable optical element, in which consumption voltage is reduced while voltage to be applied to a core layer is effectively and sufficiently ensured and optical loss amount of the optical waveguide is contained, by reducing the distance between a lower electrode and an upper electrode as much as possible.

An optical element according to the present invention includes: a substrate; and an optical waveguide provided on the substrate and made of an electrooptic material, in which the optical waveguide is provided with a core layer, and a lower clad layer and an upper clad layer holding the core layer therebetween, and in which, of the lower clad layer and the upper clad layer, at least the lower clad layer is made of a material containing conductive oxide.

An optical-loss measurement apparatus according to the present invention includes: a prism receiving an incident light; and an optical intensity measurer measuring optical intensity, in which the prism is set on an optical waveguide in a freely movable manner with respect to a member to be measured including the optical waveguide being an optical-loss measurement target, and in which the optical intensity measurer measures intensity of a light scattered from an end surface of the optical waveguide in the vicinity of the end surface.

An optical-loss measurement method according to the present invention includes the steps of: setting a prism in a freely movable manner on an optical waveguide with respect to a member to be measured including the optical waveguide being an optical-loss measurement target; guiding light in the optical waveguide substantially in parallel therewith using the prism while the light is in an irreflexive state; and measuring, in a vicinity of an end surface of the optical waveguide, an intensity of a light scattered from an end surface of the optical waveguide in accordance with a set position of the prism

### BRIEF DESCRIPTION OF THE DRAWINGS

FIG. 1 is a characteristic chart showing an optical loss of a PLZT optical waveguide formed on an STO substrate;

FIG. 2 is a characteristic chart showing an optical loss of the PLZT optical waveguide formed on an Nb—STO substrate;

FIG. 3 is a characteristic chart showing the optical losses of the SRO and PLZT optical waveguides formed on the STO substrate;

FIG. 4 is a characteristic chart showing the optical losses of the LSCO and PLZT optical waveguides formed on the STO substrate;

FIG. 5 is a characteristic chart showing a relation between wavelengths of the incident lights and light transmittances in the cases where SRO is used and where LSCO is used, respectively;

FIGS. 6A and 6B are schematic diagrams showing an outline structure of an optical deflection element according to a first embodiment;

FIG. 7 is a schematic diagram showing an outline structure of an optical-loss measurement apparatus according to a second embodiment;

FIGS. 8A and 8B are explanation views of a dependency of the incident light and a reflected light at the end surface of a plane optical waveguide on an incident angle into a prism;

FIG. 9 is a characteristic chart showing a measurement result of a relation between an angle of the incident light and an optical intensity measured using an actual plane optical waveguide;

FIG. 10 is a characteristic chart showing a relation between an optical-intensity peak value P and a position L of the prism 11 based on the measurement;

FIG. 11 is a characteristic chart showing the measurement result of the optical loss when adopting scattered light detection method;

FIG. 12 is a characteristic chart showing the measurement result of the optical loss using an optical-loss measurement apparatus according to a second embodiment;

FIG. 13 is a schematic diagram showing an outline structure of an optical-loss measurement apparatus according to a modification example of the second embodiment; and

FIGS. 14A and 14B are characteristic charts showing various measurement examples using the optical-loss measurement apparatus according to the modification example of the second embodiment.

### DETAILED DESCRIPTION OF THE PREFERRED EMBODIMENTS

—Basic Gist of Present Invention—

In order to ensure enough voltage to be applied to a core layer while containing consumption voltage of an optical element, what to do is only to produce one of, or preferably both of clad layers holding the core layer from its upper and lower sides with a conductive material. When the lower and upper clads are made of the conductive material, they also serve as lower and upper electrodes, thereby the distance between the electrodes comes to the thickness of the core layer, in other words, the distance between the electrodes can be reduced to the maximum extent possible. With this structure, it is possible to ensure enough voltage to be applied to the core layer while reducing consumption voltage.

However, in that case, the conductive material should be selected in consideration of the relation between the material of the core layer and the material of the substrate. The present invention adopts, as a basis of conductive material selection, optical loss amount of an optical waveguide, and aims to contain the optical loss amount of the optical waveguide to a low value. As will be described below, the present inventor has found that the conductive oxide is most suitable as a conductive material for, at least, the lower clad (preferably, both the lower and upper clads).

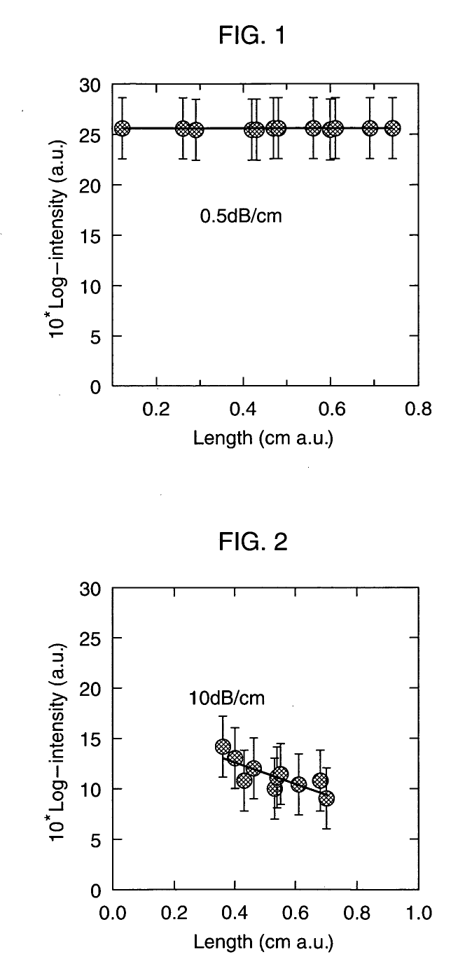

First, as to the optical element using an insulating material, STO here, for its substrate, the optical loss amount of the optical waveguide is measured. Here, as an optical waveguide (core layer), a layer having a film thickness of about 2 μm is formed on the substrate using (Pb_{1-y}La_{(3/2)y})(Zr₁₋ₓTiₓ)O₃ (0≦x, y≦1) (PLZT: 9/65/35) as a material. The optical loss amount is measured using a light at a wavelength of 1.55 μm as an incident light. The measurement result is shown in FIG. 1. Since the STO being an insulating material does not absorb light, there is found little optical loss and, as an optical loss amount, a minute value, namely 0.5 dB is indicated in a TE mode (in the polarization direction having no electric field component in the propagated direction of light). Based on this, it is found that, when the substrate does not absorb light, the PLZT (9/65/35) shows little optical loss (approximately 0.5 dB/cm or below level).

Next, the optical loss amount is measured as to a conventional optical element (the same as of Patent document 1) using Nb—STO monocrystal as a conductive material for its substrate. Here, in the same manner as above, a layer having a film thickness of about 2 μm is formed as an optical waveguide (core layer) on the substrate using PLZT (9/65/35) as a material. The measurement is made using a light at a wavelength of 1.55 μm as an incident light. The measurement result is shown in FIG. 2. A large value, 10 dB/cm is indicated as optical loss in the TE mode. When reviewing this result together with the former result, it is found that when the Nb—STO monocrystal is used as a conductive material of the substrate, the Nb—STO absorbs the light at a wavelength of 1.55 μm and thereby causes large optical loss of the optical waveguide, so that it is difficult to prove effectiveness as an optical element.

Based on the above review, a case where conductive oxide is used as a conductive material for the clad will be described.

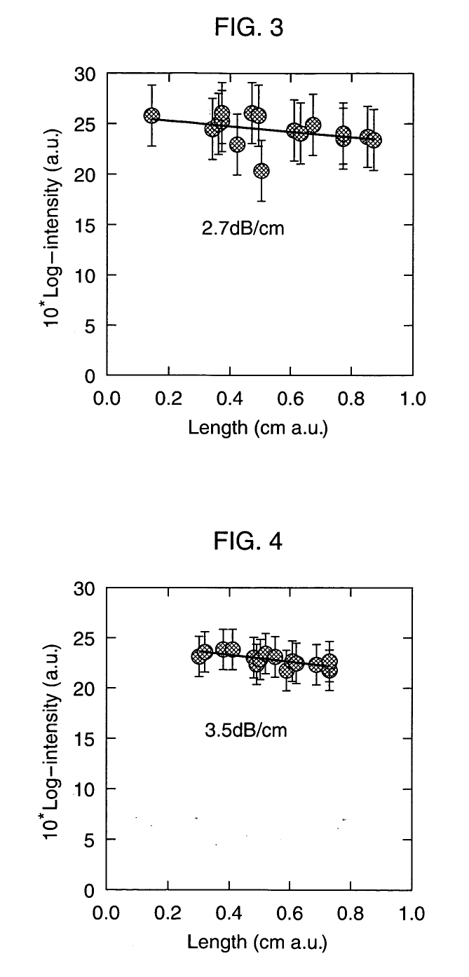

First, a case where SrRuO₃ (SRO) is used as a conductive oxide will be described. Here, the SRO having a film thickness of about 100 nm is formed on a STO substrate of an insulating nature, and then PLZT (9/65/35) having a film thickness of about 2 μm is formed on the SRO as an optical waveguide (core layer). The measurement result is shown in FIG. 3. A relatively small value, 2.7 dB/cm is indicated as optical loss in the TE mode.

Subsequently, a case where (LaₓSr₁₋ₓ)CoO₃ (0≦x≦1) (LSCO) is used as a conductive oxide will be described. Here, the LSCO having a film thickness of about 150 nm is formed on the STO substrate of an insulating nature, and then PLZT (9/65/35) having a film thickness of about 2 μm is formed on the LSCO as an optical waveguide (core layer). The measurement result is shown in FIG. 4. A relatively small value, 3.5 dB/cm is indicated as optical loss in the TE mode.

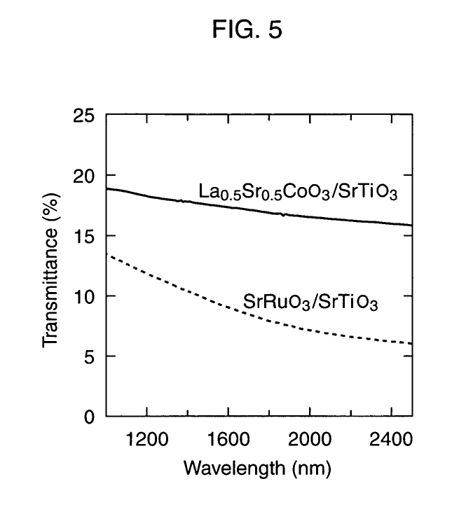

Then, the relation between wavelengths of the incident light and light transmittances is inspected in the cases of using the above-described SRO and LSCO, respectively. The measurement result is shown in FIG. 5. Thus, it is found, in both the cases, that relatively preferable light transmittances are shown in a wide range from around 1000 nm to around 2500 nm.

Backed by the above results, as a conductive material at least for the lower clad (preferably, for both the lower and upper clads), the use of the conductive oxide can ensure sufficient voltage to be applied to the core layer and contain optical loss of the optical waveguide to a low value while containing consumption voltage of the optical element.

The detail description of the experimental result is omitted here though, as a conductive oxide used as a material for the clad, (ReₓSr₁₋ₓ)CoO₃ (0≦x≦1), (ReₓSr₁₋ₓ)MnO₃ (0≦x≦1), Sr₁₋ₓCaₓRuoO₃ (0≦x≦1), Sr₁₋ₓBaₓRuoO₃ (0≦x≦1) and the like are also preferable in addition to SRO and LACO.

Note that, in Japanese Patent Application Laid-Open No. Hei06-4708 (Patent document 2), an example using a compound semiconductor (InP) as a conductive material for the clad of the optical waveguide is disclosed. The Patent document 2 lacks verification and experimental proof regarding the optical loss amount of the optical waveguide as described above, and considering personal chemistry of the substrate and the core layer, it is thought to be difficult to reduce the optical loss amount sufficiently.

### Preferred Embodiments Applying Present Invention

Hereinafter, specific embodiments applying the present invention will be described with reference to the drawings.

### First Embodiment

In the present embodiment, an example applying the present invention to an optical deflection element being an optical element will be disclosed. The optical deflection element is the optical element deflecting an incident light at a desired angle and then outputting it.

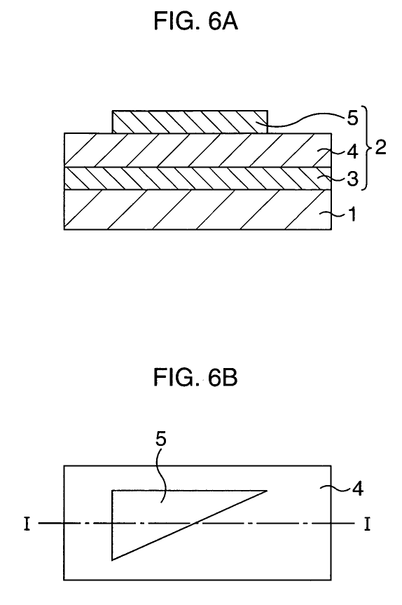

FIG. 6 are schematic diagrams showing a main structure of the optical deflection element according to the first embodiment, in which FIG. 6B is plan view and FIG. 6A is a sectional view taken along the I-I line in FIG. 6B.

This optical deflection element is composed of a substrate 1 and an optical waveguide 2 made of an electrooptic material and formed on a substrate 1.

The substrate 1 contains an insulating material, here SrTiO₃ (STO), as its primary component, and for example, it is structured such that the crystal orientation of the major growth face is (100) using STO containing 1% of Nb as a material.

The optical waveguide 2 is a so-called slab waveguide, which is formed by two or more electro-optic effect films overlapped, here three films; and specifically, a core layer 4 in which an optical path is to be formed is held between a lower clad layer 3 and an upper clad layer 5.

As an electrooptic material for the core layer 4, it is preferable that contains, for example, Pb(Zr₁₋ₓTiₓ)O₃ (0≦x≦1), (Pb_{1-y}La_{(3/2)y})(Zr₁₋ₓTiₓ)O₃ (0≦x,y≦1), Pb(B′_{1/3}B″_{2/3})ₓTi_{y}Zr_{1-x-y}O₃ (0≦x, y≦1, B′ is a bivalent transition metal, and B″ is a quinquevalent transition metal), Pb(B′_{1/2}B″_{1/2})ₓTi_{y}Zr_{1-x-y}O₃ (0≦x, y≦1, B′ is a bivalent transition metal, and B″ is a quinquevalent transition metal) and one kind selected from Pb(B′_{1/3}B′_{2/3})ₓTi_{y}Zr_{1-x-y}O₃ (0≦x, y≦1, B′ is a sixivalent transition metal, and B″ is a tervalent transition metal), Ba(FeₓNb₁₋ₓ)O₃ (0≦x≦1) and (1-x) NaNbO₃.xKNbO₃ (0≦x≦1), which has a simple perovskite structure being a ferroelectric having large electrooptic effect.

Here, the respective electrooptic effect films of the optical waveguide 2 are epitaxial films formed by epitaxial growth, in which the crystal orientations of their major growth faces are, for example, (100).

Further, it is also preferable to use: an electro-optic material of a tungsten bronze structure, for example, that contains one kind selected form (Sr₁₋ₓBaₓ)Nb₂O₆ (0≦x≦1), (Sr₁,Baₓ)Ta₂O₆ (0≦x≦1), PbNb₂O₆, and Ba₂NaNb₅O₁₅; or an electrooptic material of a bismuth-layered structure, for example, that contains one kind selected from, (Bi₁₋ₓRₓ)Ti₃O₁₂ (R=rare-earth element: 0≦x≦1), SrBi₂Ta₂O₉ and SrBi₄Ti₄O₁₅.

The lower clad layer 3 is formed by a conductive oxide as a material, also serving as a lower electrode to apply voltage to the core layer 4. Note that a desired lower electrode may be formed separately under the lower clad layer.

As a conductive oxide for that, it is preferable that contains, as its primary component, at least, one kind selected from SrRuO₃, (LaₓSr₁₋ₓ)CoO₃ (0≦x≦1) (ReₓSr₁₋ₓ)CoO₃ (0≦x≦1), (ReₓSr₁₋ₓ)MnO₃ (0≦x≦1), Sr₁₋ₓCaₓRuoO₃ (0≦x≦1) and Sr₁₋ₓBaₓRuoO₃ (0≦x≦1).

The upper clad layer 5 is formed by the conductive oxide as a material, also serving as an upper electrode (deflection electrode) to apply voltage to the core layer 4. Note that a desired upper electrode may be formed separately on the upper clad layer. The upper clad layer 5 is formed on the core layer 4, for example, to have a triangle shape, having a function to deflect the incident light at a desired angle and output it when desired voltage is applied to between itself and the lower clad layer 3.

As a conductive oxide for the upper clad layer 5, as in the case of the lower clad layer 3, it is preferable that contains, as its primary component, at least one selected from SrRuO₃, (LaₓSr₁₋ₓ)CoO₃ (0≦x≦1), (ReₓSr₁₋ₓ)CoO₃ (0≦x≦1), (ReₓSr₁₋ₓ)MnO₃ (0≦x≦1), Sr₁₋ₓCaₓRuoO₃ (0≦x≦1) and Sr₁₋ₓBaₓRuoO₃ (0≦x≦1).

Note that, generally, the lower clad layer 3 and the upper clad layer 5 are formed with the same material, whereas a case in which they are formed with different conductive oxides is also conceivable.

Here, a manufacturing method of the optical deflection element according to the present embodiment will be described.

On the substrate 1 formed by SrTiO₃ of which crystal orientation of the major face is (100), the lower clad layer 3 is formed by depositing La_{0.5}Sr_{0.5}CoO₃ being a conductive oxide to have a film thickness of about 40 nm; the core layer 4 is formed thereon by depositing PLZT (9/65/35) of a reflective index of 2.40 (wavelength 1.55 nm) to have a film thickness of about 2 μm; and the upper clad layer 5 is formed by depositing La_{0.5}Sr_{0.5}CoO₃ to have a film thickness of about 40 nm.

Hereinafter, formation methods of PLZT of the core layer 4 and La_{0.5}Sr_{0.5}CoO₃ of the upper and lower clad layers 11, 13 will be described, respectively.

PLZT is formed by epitaxial growth by sol-gel method. As a sol-gel solution for PLZT, Pb(CH₃COO)₂.3H₂O [lead acetate], La(i-OC₃H₇)₃ [lanthanum isopropoxide], Ti(i-OC₃H₇)₄ [titanium isopropoxide], Zr(OC₃H₇)₄ [zirconium propoxide], which are organic compounds of the constituent metal elements, and CH₃COCH₂COCH₃ [2,4-pentanedione] as a stabilizer, are synthesized under reflex with CH₃C₂H₄OH [2-methoxyethanol] being a solvent.

In order to produce PLZT with composition of (9/65/35), simply set the molar ratio of Pb(CH₃COO).3H₂O/La(i-OC₃H₇)₃ to 101/9 and set the same of Zr(OC₃H₇)₄/Ti(i-OC₃H₇)₄ to 65/35. The sol-gel solution is coated on the substrate 1 by spin-coat method, and the substrate 1 is precalcinated at a temperature of 350° C. and then calcinated at a temperature of 750° C. in an oxygen atmosphere. The film thickness can be grown at a time is about 120 nm, and therefore, the coating, precalcination and calcination are repeated to the extent that the desired film thickness is attained.

La_{0.5}Sr_{0.5}CoO₃ is produced by so-called laser-ablation method (PLD method).

As has been described, according to the present embodiment, by containing the distance between the lower electrode and the upper electrode being the distance between the lower clad layer 3 and the upper clad layer 5 as much as possible, the highly-reliable optical element, in which consumption voltage is reduced while voltage to be applied to the core layer 4 is effectively and sufficiently ensured and the optical loss amount of the optical waveguide 2 is contained, is realized.

### Second Embodiment

In the present embodiment, an optical-loss measurement apparatus to measure optical loss amount of an optical waveguide being a component of an optical element will be disclosed.

As has been described in the first embodiment, it is necessary for the evaluation of optical characteristics of the optical element to measure the optical loss amount of the optical waveguide of the optical element (optical deflection element) accurately.

However, the accurate measurement of the optical loss amount of the optical waveguide has been difficult. The optical loss measurement under study has been the measurement of the optical intensity of a transmitted light of an oxide dielectric formed on a transparent substrate (the light entered from the surface and transmitted through the oxide dielectric and transparent substrate). However, this method lacks the relevance with the optical loss when it is used as an actual optical waveguide and, therefore, a simple measurement method of the optical loss when used as the optical waveguide has been demanded.

As conventional optical-loss measurement methods, there are a cutback method, a prism moving method and a scattered light detection method.

The cutback method is a method measuring the optical loss from the optical intensity with respect to a sample of a length by appropriately changing the length of the sample. This method allows the measurement in the form suited to the actual optical waveguide, however, has problems that the method is a destructive measurement, and that requires substantial experience in order to enter the light into the optical waveguide accurately, and so forth.

The prism moving method is an approach performing the measurement using two prisms. The optical loss measurement is performed based on the optical intensity of an outgoing light being a light entered into the optical waveguide from the prism and extracted therefrom by changing the position of the prism. With this measurement method, the optical loss can be measured relatively easily; however, the light angles entering and outgoing into/from the prism should be matched accurately, having made the measurement be difficult.

The scattered light detection method is a method measuring the optical loss by entering a light into the optical waveguide from the prism and measuring the scattering on the surface of the optical waveguide. This is a simple method without the need of extracting the outgoing light from the prism, however, there are problems that the correct optical loss cannot be measured when a light absorbent (for example, a substrate) exists under the plane optical waveguide, and so forth.

In the present embodiment, in order to bring a solution to the above problems, an optical-loss measurement apparatus without the needs for the precise formation of an end surface of the optical waveguide and the accurate adjustment of the angles of the incident and outgoing lights to/from the prism and capable of measuring the optical loss amount accurately even when the light absorbent member (substrate and so on) exists under the optical waveguide, will be disclosed.

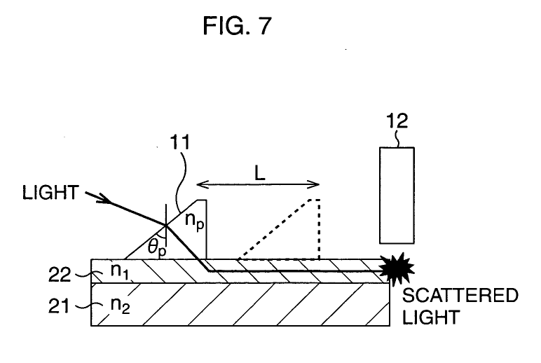

FIG. 7 is a schematic diagram showing an outline structure of the optical-loss measurement apparatus according to the second embodiment.

The optical-loss measurement apparatus is an apparatus adopting a prism coupling method and composed of a prism 11 receiving an incident light and an optical intensity detector 12 detecting the optical intensity.

The prism 11 is set on an optical waveguide 22 in a freely movable manner with respect to a member to be measured including the optical waveguide (a plane optical waveguide 22 here) being an optical-loss measurement target, in which a light is guided such that the light is oriented in the optical waveguide 22 almost in parallel therewith while it is in the irreflexive state. The member to be measured is a substrate 21 having the plane optical waveguide 22 formed thereon. In FIG. 7, the refractive index of the prism 11 is denoted by ‘nₚ’, the refractive index of the plane waveguide 22 is denoted by ‘n₁’ and the refractive index of the substrate 21 is denoted by ‘n₂’.

The optical intensity detector 12 measures the intensity of the light scattered from the end surface of the plane optical waveguide 22 in accordance with the set position of the prism 11 while it is in the vicinity of the end surface.

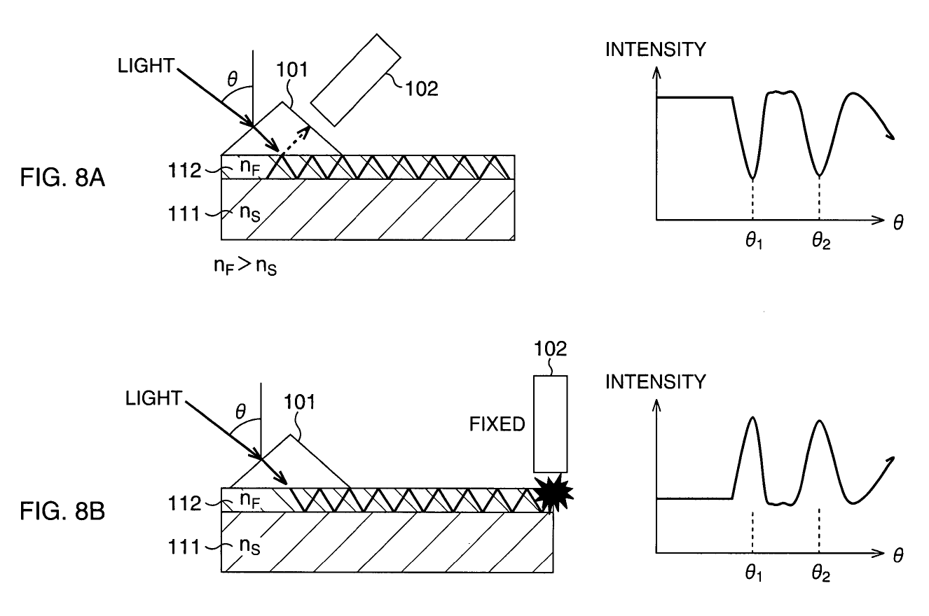

Here, the description will be given of the dependency of the incident light and the reflected light at the end surface of the plane optical waveguide on the prism incident angle. FIGS. 8A and 8B are reference views to illustrate the dependency on the prism incident angle.

As shown in FIG. 8A, when an optical-intensity detector 102 detects a reflected light from the surface of a plane waveguide 112 formed on a substrate 111, there are incident angles θ₁, θ₂ indicating negative peak values of optical intensities. In FIG. 8, the refractive index of the plane optical waveguide 112 is denoted by ‘n_{F}’ and the refractive index of the substrate 21 is denoted by ‘nₛ’, where n_{F}>nₛ.

Further, as shown in FIG. 8B, when the optical intensity detector 102 detects the light scattered at the end surface of the plane optical waveguide 112 after repeatedly reflected in the plane optical waveguide 112, there are incident angles θ₁, θ₂ indicating positive peak values of optical intensities.

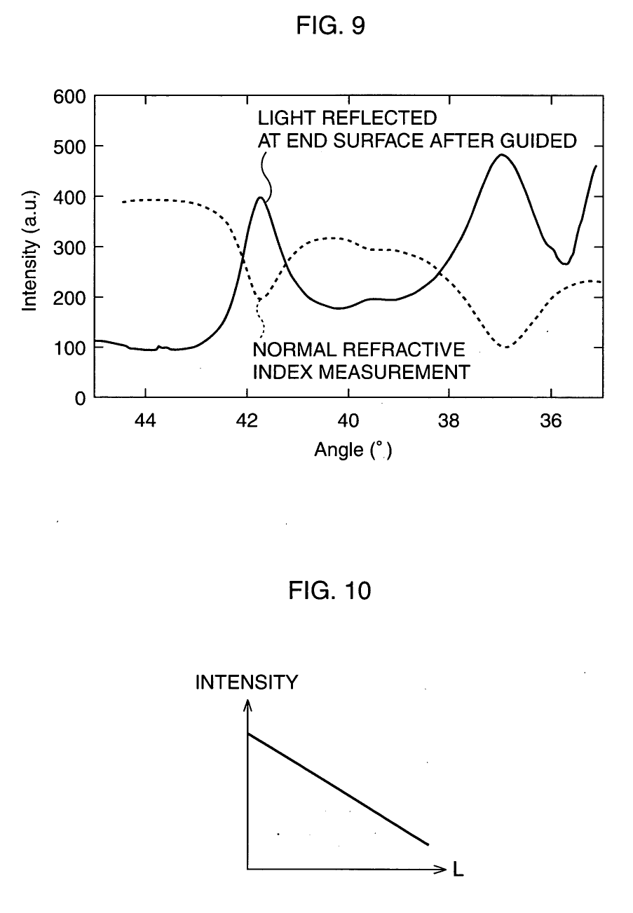

The measurement result measuring the relation between the angle of the incident light and the optical intensity using an actual plane optical waveguide is shown in FIG. 9. Thus, it is found that the light entered into a prism 111 directly becomes the reflected light at the end surface.

Note that a technique to obtain the optical loss of the plane optical-waveguide using the apparatus structure shown in FIG. 8 is disclosed in Japanese Patent Application Laid-Open No. Hei07-243941 (Patent document 3). However, in that case, there is concern that the accurate optical-loss detection is difficult due to light absorption by the substrate 111.

Subsequently, a measurement method of the optical-loss amount using the optical-loss measurement apparatus in FIG. 7 will be described.

In FIG. 7, first, the prism 11 is set on the plane optical waveguide 22. With the optical intensity detector 12, the optical intensities of the reflected lights at the end surface of the plane optical waveguide 22 are detected while moving the prism 11 rightward in the drawing and changing a distance L, in which the initial set position of the prism is defined as zero (0).

The relation between an optical-intensity peak value P and the position L of the prism 11 based on the measurement is shown in FIG. 10.

In this manner, the relation between the both almost shows a straight decline of P along with the increase of L.

The optical-loss measurement apparatus obtains an optical loss α from the relation between the optical-intensity peak value P and the position L of the prism 11. The optical loss α is obtained by the equation below.
α=|10*log(ΔP/ΔL)|

Here, the measurement result of the optical loss in the plane optical waveguide composed of PLZT formed on an Nb—STO substrate will be shown. The wavelength measured is 1.55 μm and a prism composed of Si monocrystal is used.

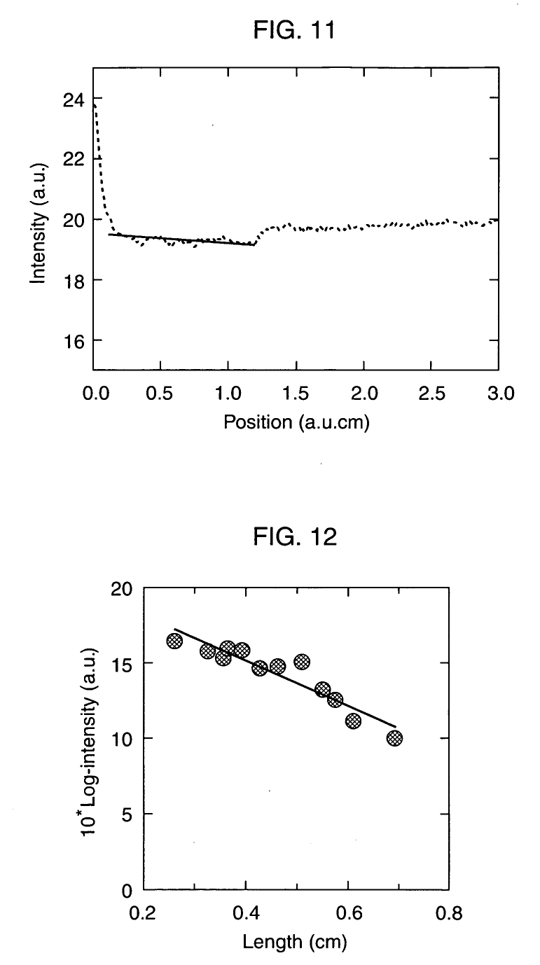

First, the measurement result of the optical loss when the scattered light detection method is adopted is shown in FIG. 11.

Based on the slop in the range from 0.2 cm to 0.5 cm of the horizontal axis in FIG. 11, the optical loss can be measured to be approximately 0.3 dB/cm. However, in this case, since the Nb—STO substrate existing under the plane optical waveguide absorbs the light in practice, naturally, the actual optical loss amount of the plane optical waveguide is considered to be even higher. This is supported by the fact that the loss obtained by the difference in optical intensities of the outgoing lights between the cases where the light is guided in the plane optical waveguide composed of PLZT and where the light is not guided thereinto is proved to be about 20 dB/cm.

Subsequently, the result of the optical loss measured by the optical-loss measurement apparatus according to the present embodiment is shown in FIG. 12.

The optical intensities of the lights scattered at the end surface of the optical waveguide 12 are plotted with respect to the positions L of the prism 11. Based on the slop, the optical loss is proved to be about 15 dB/cm. Based on this result, it is found that, even when a light-absorbing member such as a substrate exists under the optical waveguide, the optical loss can be measured accurately and easily with the optical-loss measurement apparatus according to the present embodiment.

As described above, according to the present embodiment, the optical-loss measurement apparatus without the needs for the precise formation of the end surface of the optical waveguide and the accurate adjustment of the angles of the incident and outgoing lights to/from the prism and capable of measuring the optical loss amount accurately even when the light absorbent member (substrate and so on) exists under the optical waveguide, is realized.

### MODIFICATION EXAMPLE

Hereinafter, a modification example according to the second embodiment will be described. Note that the same numerals and symbols will be used for the same components or the like as of the optical-loss measurement apparatus according to the second embodiment, and detailed description thereof will be omitted.

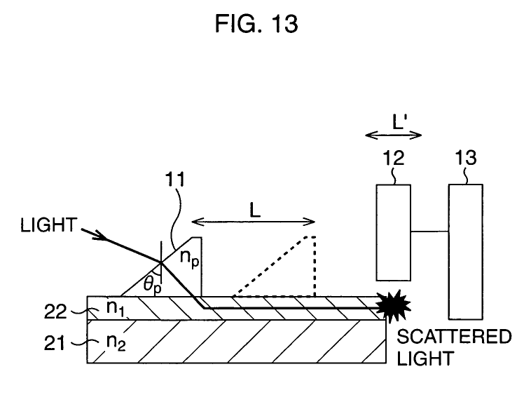

FIG. 13 is a schematic diagram showing an outline structure of the optical-loss measurement apparatus according the modification example of the second embodiment.

In addition to the apparatus components in FIG. 7 according to the second embodiment, this optical-loss measurement apparatus is further composed of an optical loss calculating unit 13 calculating the optical loss amount based on the optical intensity detected by the optical intensity detector 12.

The optical loss calculating unit 13 calculates the optical loss amount by integrating the optical intensity measured by the optical intensity detector 12.

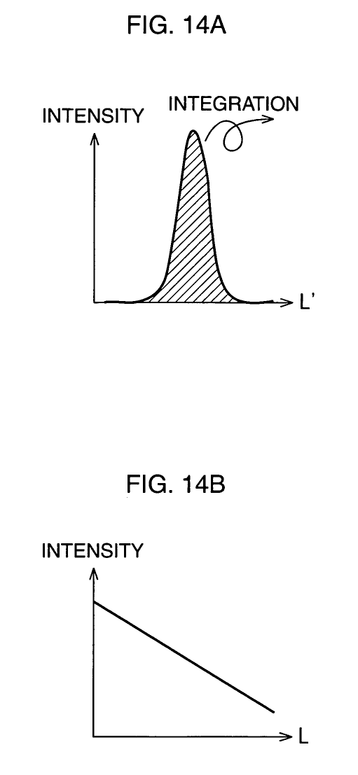

When the optical intensity is measured by the optical intensity detector 12, as shown in FIG. 14A, the optical intensity is indicated as a curved line depending on a measurement position L′ of the optical intensity detector 12. Here, in many cases, the peak value P of the optical intensity can be deemed as the optical intensity, however, the area surrounded by the curved line, namely the integrated value is the more accurate optical intensity.

Based on this fact, the present modification example is configured so that the optical loss calculating unit 13 integrates the optical intensity measured by the optical intensity detector 12 to thereby calculate the optical loss amount as shown in FIG. 14B. With this configuration, in addition to the effects obtained by the second embodiment, more accurate optical loss amount can be measured.

According to the present invention, by containing the distance between a lower electrode and an upper electrode as much as possible, a highly-reliable optical element, in which consumption voltage is reduced while voltage to be applied to a core layer is effectively and sufficiently ensured and optical loss amount of the optical waveguide is contained, is realized.

The present embodiments are to be considered in all respects as illustrative and no restrictive, and all changes which come within the meaning and range of equivalency of the claims are therefore intended to be embraced therein. The invention may be embodied in other specific forms without departing from the spirit or essential characteristics thereof.

What is claimed is:

1. An optical element comprising:
a substrate; and
an optical waveguide provided on said substrate and made of an electrooptic material,
wherein said optical waveguide includes a core layer, and a lower clad layer and an upper clad layer holding the core layer therebetween, and
wherein, of the lower clad layer and the upper clad layer, at least the lower clad layer is made of the material containing conductive oxide.

2. The optical element according to claim 1,
wherein both the lower clad layer and the upper clad layer are made of a material containing the conductive oxide.

3. The optical element according to claim 1,
wherein the conductive oxide has at least one kind selected from SrRuO₃, (LaₓSr₁₋ₓ)CoO₃ (0≦x≦1) (ReₓSr₁₋ₓ)CoO₃ (0≦x≦1), (ReₓSr₁₋ₓ)MnO₃ (0≦x≦1), Sr₁₋ₓCaₓRuoO₃ (0≦x≦1) and Sr₁₋ₓBaₓRuoO₃ (0≦x≦1), as its primary component.

4. The optical element according to claim 1,
wherein said substrate has at least one kind selected from SrTiO₃ and LaAlO₃ as its primary component.

5. The optical element according to claim 1,
wherein the core layer is formed by epitaxial growth with respect to crystal orientation of an insulating film substrate

6. The optical element according to claim 5,
wherein a major growth face of the core layer is (100).

7. The optical element according to claim 1,
wherein the core layer has a simple perovskite structure.

8. The optical element according to claim 7,
wherein the simple perovskite structure contains Pb(Zr₁₋ₓTiₓ)O₃ (0≦x≦1), (Pb_{1-y}La_{(3/2)y})(Zr₁₋ₓTiₓ)O₃ (0≦x, y≦1), Pb(B′_{1/3}B″_{2/3})ₓTi_{y}Zr_{1-x-y}O₃ (0≦x, y≦1, B′ is a bivalent transition metal, and B″ is a quinquevalent transition metal), Pb(B′_{1/2}B″_{1/2})ₓTi_{y}Zr_{1-x-y}O₃ (0≦x, y≦1, B′ is a bivalent transition metal, and B″ is a quinquevalent transition metal) and one kind selected from Pb(B′_{1/3}B″_{2/3})ₓTi_{y}Zr_{1-x-y}O₃ (0≦x, y≦1, B′ is a sixivalent transition metal, and B″ is a tervalent transition metal), Ba(FeₓNb₁₋ₓ)O₃ (0≦x≦1) and (1-x) NaNbO₃.xKNbO₃ (0≦x≦1).

9. The optical element according to claim 1,
wherein, of the core layers, at least one layer has a tungsten bronze structure.

10. The optical element according to claim 9,
wherein the tungsten bronze structure contains one kind selected from (Sr₁₋ₓBaₓ)Nb₂O₆ (0≦x≦1), (Sr₁₋ₓBaₓ)Ta₂O₆ (0≦x≦1), PbNb₂O₆, and Ba₂NaNb₅O₁₅.

11. The optical element according to claim 1,
wherein, of the core layers, at least one layer has a bismuth-layered structure.

12. The optical element according to claim 11,
wherein the bismuth-layered structure contains one kind selected from (Bi₁₋ₓRₓ)Ti₃O₁₂ (R is a rare-earth element: 0≦x≦1), SrBi₂Ta₂O₉, and SrBi₄Ti₄O₁₅.

13. An optical-loss measurement apparatus according to the present invention comprising:
a prism receiving an incident light; and
an optical intensity measurer measuring light intensity,
wherein said prism is set on an optical waveguide in a freely movable manner with respect to a member to be measured including the optical waveguide being an optical loss measurement target, and
wherein said optical intensity measurer measures, in a vicinity of the end surface, an intensity of a light scattered from an end surface of the optical waveguide.

14. The optical-loss measurement apparatus according to claim 13, further comprising an optical loss calculator integrating the optical intensity measured by said optical intensity measurer to calculate an optical loss.

15. An optical loss measurement method comprising the steps of:
setting a prism on an optical waveguide in a freely movable manner with respect to a member to be measured including the optical waveguide being an optical loss measurement target;
guiding a light in the optical waveguide substantially in parallel therewith using the prism while the light is in an irreflexive state; and
measuring, in a vicinity of an end surface of the optical waveguide, the intensity of a light scattered from an end surface of the optical waveguide in accordance with a set position of the prism.

16. The optical loss measurement method according to claim 15,
wherein the optical loss is calculated by integrating the measured intensity of the light.
